(19) United States
(12) Patent Application Publication
(10) Pub. No.: US 2012/0246946 A1
(43) Pub. Date: Oct. 4, 2012

(54) Knife With a Metal End Cap and Method for Fixing the End Cap

(76) Inventors: Thomas Kreitz, Solingen (DE); Paul Boldt, Solingen (DE)

(21) Appl. No.: 13/437,313

(22) Filed: Apr. 2, 2012

(30) Foreign Application Priority Data
Mar. 31, 2011 (DE) 10 2011 015 718.2

(51) Int. Cl. B26B 3/00; B25G 3/02

(52) U.S. Cl. 30/342; 29/446

(57) ABSTRACT

A knife includes a metal blade having an integral tang, the tang having a tang end and being a flat bar shaped to carry a handle, a plastic handle having an handle end defining a well surrounding the tang end, and a metal end cap comprising an integrally formed plug section. The metal end cap is attached at the handle end to positively fit the plug section in the well. The plug section has a plug end facing the tang end and defining a recess in which the plug section encloses the tang end in a positive fit. Also provided is a method for fixing the metal end cap in the plastic well at the handle end of the knife which comprises the step of exciting the metal end cap with ultrasonic energy while inserting the metal end cap into the well to thereby plasticate the plastic in the handle.

### CROSS-REFERENCE TO RELATED APPLICATIONS

This application claims the priority, under 35 U.S.C. §§119 and 371, of German patent application No. 10 2011 015 718.2, filed Mar. 31, 2011; the prior application is herewith incorporated by reference in its entirety.

### STATEMENT REGARDING FEDERALLY SPONSORED RESEARCH OR DEVELOPMENT

Not Applicable

### FIELD OF THE INVENTION

The present invention lies in the field of knives and their end caps. The present disclosure relates to a knife with a metal blade and a tang formed integrally with the blade, this tang being a flat bar that carries the handle, made of plastic, with a metal end cap being affixed at the end of the handle and a method for affixing the end cap.

### BACKGROUND OF THE INVENTION

It is well known that the metal end cap of a knife handle can be manufactured such that the end cap is forged on the tang. It is known, alternatively, to manufacture the metal end cap as a cast part and to weld it to the end of the tang. Both manufacturing procedures are labor-intensive with regard to both the manufacture and the attachment thereof. A need exists to overcome the problems with these prior art designs.

### SUMMARY OF THE INVENTION

The invention provides a knife with a metal end cap and a method for fixing the end cap that overcome the hereinafore-mentioned disadvantages of the heretofore-known devices and methods of this general type and that provide such features that affixes the metal end cap of the knife in a simple and secure fashion and, in particular, so as to be reliable in assembly and reproducible while allowing rapid subsequent processing of the knife. In addition, the exact rotational angle of the end cap is to be secured.

According to an exemplary embodiment of the invention, the plastic at the end of the handle comprises a well that surrounds the end of the tang, the metal end cap comprises an integrally formed plug section that is located in the well so as to create a positive fit, and the end of the plug section toward the end of the tang comprises a recess and, in particular, a transverse slot by way of which the plug section encloses the end of the tang so as to create a positive fit.

In this way, secure, positive-fit affixing of the metal end cap at the plastic of the handle and on the tang is achieved, with it being ensured that the end cap cannot assume any undesired skewed position, which would cause the knife to be rejected.

In an exemplary embodiment, the well in the plastic at the end of the handle and the integral plug section is cylindrical. The outside diameter of the plug section is equal to or slightly smaller than the inside diameter of the cylindrical well in the end of the handle.

Particularly sure affixing is achieved if the plug section comprises lateral projections. The projections may be annular and positioned coaxially on the plug section. Particularly secure affixing is also achieved if the annular projections exhibit discontinuities.

In another exemplary embodiment, the plug section is held in the well at the end of the handle by friction fit.

A particularly advantageous method for affixing a metal end cap in the plastic opening at the end of the handle of a knife is achieved if the end cap is excited by ultrasonic energy while being inserted into the well, with the plastic in the handle being plasticated hereby. Achieved herein is that the plastic at the surface of the well, excited by the ultrasonic energy, flows into the spaces between the projections on the plug section.

Secure affixing and a good seal are achieved if, due to the ultrasonic energy, the lower surface of the end cap plasticates the plastic at the outside edge of the well. Here it is advantageous if the plasticated plastic flows into an annular recess located at the edge of the well.

With the foregoing and other objects in view, there is provided, in accordance with the invention, a knife comprising a metal blade having an integral tang, the tang having a tang end and being a flat bar shaped to carry a handle, a plastic handle having an handle end defining a well surrounding the tang end, and a metal end cap comprising an integrally formed plug section. The metal end cap is attached at the handle end to positively fit the plug section in the well and the plug section has a plug end facing the tang end and defining a recess in which the plug section encloses the tang end in a positive fit.

In accordance with another feature of the invention, the recess is a transverse slot.

In accordance with a further feature of the invention, the well and the plug section are cylindrical.

In accordance with an added feature of the invention, the well has an inside diameter and the plug section has an outside diameter equal to or smaller than the inside diameter of the well

In accordance with an additional feature of the invention, the cylindrical well has an inside diameter and the cylindrical plug section has an outside diameter equal to or smaller than the inside diameter of the well.

In accordance with yet another feature of the invention, the plug section has a circumference and comprises projections on the circumference.

In accordance with yet a further feature of the invention, the projections are annular and are disposed coaxially on the plug section.

In accordance with yet an added feature of the invention, the annular projections have discontinuities.

In accordance with yet an additional feature of the invention, the plug section is held in the well by a friction fit.

With the objects of the invention in view, there is also provided a method for fixing the metal end cap in the plastic well at the handle end of the knife according to invention, which comprises the step of exciting the metal end cap with ultrasonic energy while inserting the metal end cap into the well to thereby plasticate the plastic in the handle.

With the objects of the invention in view, there is also provided a method for assembling a knife, which comprises the steps of shaping an integral tang of a metal blade as a flat bar with a tang end, placing a plastic handle about the tang end, the plastic handle having an handle end defining a well surrounding the tang end, and, while positively fixing a plug section of a metal end cap in the well, exciting the metal end cap with ultrasonic energy to thereby plasticate the plastic in the handle, the plug section having a plug end facing the tang end and defining a recess in which the plug section encloses the tang end in a positive fit.

In accordance with again another mode of the invention, the well defines a well wall and the plug section has projections thereon defining spaces therebetween, and which further comprises carrying out the exciting step by flowing the plastic at the well wall into the spaces between the projections on the plug section due to the ultrasonic energy.

In accordance with again a further mode of the invention, the metal end cap has a lower surface and the well has an outside edge, and which further comprises plasticating the outside edge of the well with the lower surface of the metal end cap due to the ultrasonic energy.

In accordance with again an added mode of the invention, the well has an edge defining an annular recess, and which further comprises flowing the plasticated plastic into the annular recess.

In accordance with again an additional mode of the invention, the plug section has a circumference and comprises annular projections on the circumference defining discontinuities.

In accordance with a concomitant mode of the invention, the positive fixing step holds the plug section in the well with a friction fit.

Although the invention is illustrated and described herein as embodied in a knife with a metal end cap and a method for fixing the end cap, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Additional advantages and other features characteristic of the present invention will be set forth in the detailed description that follows and may be apparent from the detailed description or may be learned by practice of exemplary embodiments of the invention. Still other advantages of the invention may be realized by any of the instrumentalities, methods, or combinations particularly pointed out in the claims.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages all in accordance with the present invention. Advantages of embodiments of the present invention will be apparent from the following detailed description of the exemplary embodiments thereof, which description should be considered in conjunction with the accompanying drawings in which:

FIG. 1 is an axial cross-sectional view of an exemplary embodiment of a knife with an end cap according the invention in an area of a rear end of a knife handle; and

FIG. 2 is a perspective view of the end cap of FIG. 1.

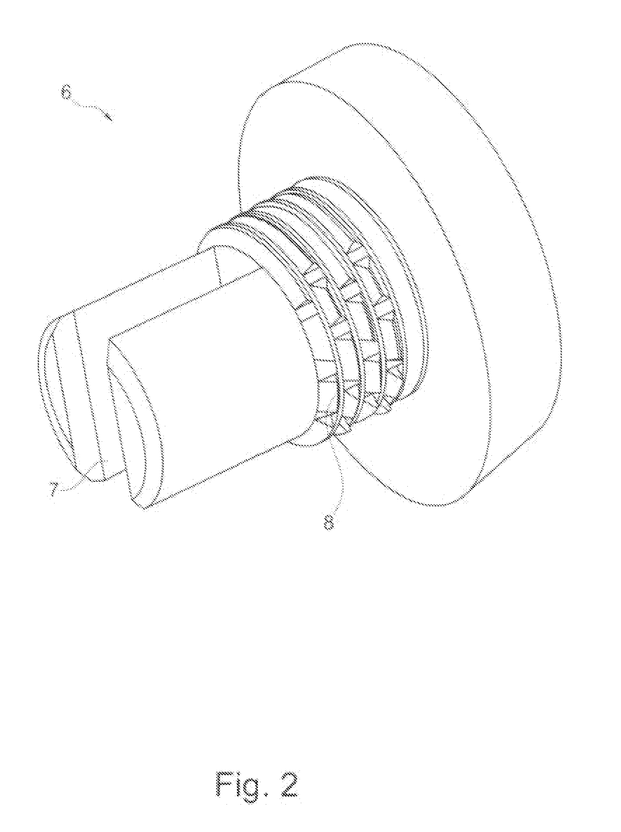

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

Alternate embodiments may be devised without departing from the spirit or the scope of the invention. Additionally, well-known elements of exemplary embodiments of the invention will not be described in detail or will be omitted so as not to obscure the relevant details of the invention.

Before the present invention is disclosed and described, it is to be understood that the terminology used herein is for describing particular embodiments only and is not intended to be limiting. The terms “a” or “an”, as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

Relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

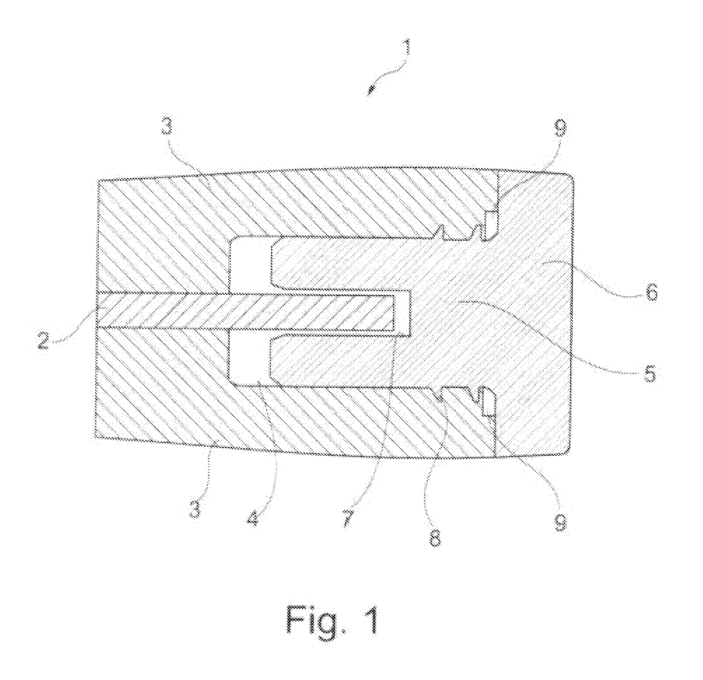

Described now are exemplary embodiments of the present invention. Referring now to the figures of the drawings in detail and first, particularly to FIG. 1, there is shown a first exemplary embodiment of a handle 1 of a knife exhibiting a metal tang 2 formed integrally with the metal blade. The tang is a flat bar that is concealed on both sides by two grip plates 3 made of plastic. Herein, the tang 2 may be visible on both sides of the handle 1 or may be concealed there by the grip plates 3 so that it is not visible.

The plastic in the handle 1 and, thus, the grip plates 3 create a cylindrical opening in the shape of a well 4, in which the metal plug section 5 of a metal end cap 6 is located in positive fit, with the plug section 5 being integrally formed with the end cap 6 and the end cap 6 concealing the plastic at the end of the handle 1. Here, the outside diameter of the cylindrical plug section 5 corresponds to the inside diameter of the well 4 so that the plug section 5 is held in the well 4 by positive fit and, in particular, by friction fit.

The end of the plug section 5 toward the tang 2 comprises a recess 7 that encloses and creates a positive fit with the tang 2. The recess is, in an exemplary embodiment, in the form of a diametric transverse slot in which the end of the tang is located to create a positive fit. In this way, the end cap 6 is held on the tang 2 so that it cannot be rotated.

At the cylindrical outside surface of the plug section 5 there are projections 8 that are, for example, annular and disposed coaxially on the plug section 5. Here, the annular projections 8 may exhibit discontinuities in order to create particularly secure and rotation-proof affixing in the plastic of the handle. This results in secure affixing of the plug section 5 in the well 4.

In a particularly advantageous affixing method, the end cap 6 is excited with ultrasonic energy during its insertion into the well 4, whereby the plastic in the handle 1 is plasticated in the area of the well 4 and the rear end of the handle. In this way, the plastic of the well wall is caused to flow into the spaces between the projections 8.

Excited by the ultrasonic energy, the lower surface of the end cap 6 also plasticates the outside edge of the well 4 and, in that way, the end of the handle too, so that a very good seal is achieved, sure to prevent the ingress of moisture into the inside of the handle. Here, the plasticated plastic may flow into an annular recess 9 at the end of the handle, located at the edge of the well.

The foregoing description and accompanying drawings illustrate the principles, exemplary embodiments, and modes of operation of the invention. However, the invention should not be construed as being limited to the particular embodiments discussed above. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A knife, comprising:
a metal blade having an integral tang, the tang having a tang end and being a flat bar shaped to carry a handle;
a plastic handle having an handle end defining a well surrounding the tang end; and
a metal end cap comprising an integrally formed plug section, the metal end cap being attached at the handle end to positively fit the plug section in the well, the plug section having a plug end:
facing the tang end; and
defining a recess in which the plug section encloses the tang end in a positive fit.

2. The knife according to claim 1, wherein the recess is a transverse slot.

3. The knife according to claim 1, wherein the well and the plug section are cylindrical.

4. The knife according to claim 1, wherein:
the well has an inside diameter; and
the plug section has an outside diameter equal to or smaller than the inside diameter of the well.

5. The knife according to claim 3, wherein:
the cylindrical well has an inside diameter; and
the cylindrical plug section has an outside diameter equal to or smaller than the inside diameter of the well.

6. The knife according to claim 1, wherein the plug section has a circumference and comprises projections on the circumference.

7. The knife according to claim 6, wherein the projections are annular and are disposed coaxially on the plug section.

8. The knife according to claim 7, wherein the annular projections have discontinuities.

9. The knife according to claim 1, wherein the plug section is held in the well by a friction fit.

10. A method for fixing the metal end cap in the plastic well at the handle end of the knife according to claim 1, which comprises:
exciting the metal end cap with ultrasonic energy while inserting the metal end cap into the well to thereby plasticate the plastic in the handle.

11. The method according to claim 10, wherein the well defines a well wall and the plug section has projections thereon defining spaces therebetween, and which further comprises carrying out the exciting step by flowing the plastic at the well wall into the spaces between the projections on the plug section due to the ultrasonic energy.

12. The method according to claim 10, wherein the metal end cap has a lower surface and the well has an outside edge, and which further comprises plasticating the outside edge of the well with the lower surface of the metal end cap due to the ultrasonic energy.

13. The method according to claim 11, wherein the metal end cap has a lower surface and the well has an outside edge, and which further comprises plasticating the outside edge of the well with the lower surface of the metal end cap due to the ultrasonic energy.

14. The method according to claim 12, wherein the well has an edge defining an annular recess, and which further comprises flowing the plasticated plastic into the annular recess.

15. The method according to claim 13, wherein the well has an edge defining an annular recess, and which further comprises flowing the plasticated plastic into the annular recess.

16. A method of assembling a knife, which comprises:
shaping an integral tang of a metal blade as a flat bar with a tang end;
placing a plastic handle about the tang end, the plastic handle having an handle end defining a well surrounding the tang end; and
while positively fixing a plug section of a metal end cap in the well, exciting the metal end cap with ultrasonic energy to thereby plasticate the plastic in the handle, the plug section having a plug end:
facing the tang end; and
defining a recess in which the plug section encloses the tang end in a positive fit.

17. The method according to claim 16, wherein the plug section has a circumference and comprises annular projections on the circumference defining discontinuities.

18. The method according to claim 16, wherein the positive fixing step holds the plug section in the well with a friction fit.

19. The method according to claim 16, wherein the well defines a well wall and the plug section has projections thereon defining spaces therebetween, and which further comprises carrying out the exciting step by flowing the plastic at the well wall into the spaces between the projections on the plug section due to the ultrasonic energy.

20. The method according to claim 16, wherein the metal end cap has a lower surface and the well has an outside edge, and which further comprises plasticating the outside edge of the well with the lower surface of the metal end cap due to the ultrasonic energy.

21. The method according to claim 16, wherein the well has an edge defining an annular recess, and which further comprises flowing the plasticated plastic into the annular recess.
